(19) United States
(12) Patent Application Publication
(10) Pub. No.: US 2009/0105063 A1
(43) Pub. Date: Apr. 23, 2009

(54) Dielectric Ceramic Composition

(75) Inventors: Shi Luo, Gunma-ken (JP); Takahiro Yamakawa, Saitama-Ken (JP)

Correspondence Address: THE WEBB LAW FIRM, P.C., 700 KOPPERS BUILDING, 436 SEVENTH AVENUE, PITTSBURGH, PA, 15219, US

(73) Assignee: YOKOWO CO., LTD., Tokyo (JP)

(21) Appl. No.: 12/293,016

(22) PCT Filed: Mar. 15, 2007
(86) PCT No.: PCT/JP2007/055929

§ 371 Date: Sep. 15, 2008

(30) Foreign Application Priority Data
Mar. 16, 2006 (JP) 2006-072440

(51) Int. Cl. C04B 35/03

(52) U.S. Cl. 501/123

(57) ABSTRACT

There is provided a dielectric ceramic composition having a high relative permittivity, a high frequency-quality factor, a small absolute value temperature coefficient, a low sintering temperature, and unreactivity with an internal conductor material. The dielectric ceramic composition comprises a main component represented by general formula xZnOxNlb₂O₅yCaTiO₃zCaO, wherein 37≦x≦50, 10≦y≦60, 3≦z≦40, and x+y+z=100, and a boron (B) oxide as an accessory component in an amount of 0.3 to 3.0 parts by weight in terms of B₂O₃ based on the main component.

### TECHNICAL FIELD

The present invention relates to a dielectric ceramic composition. More particularly, the present invention relates to a dielectric ceramic composition having a high relative permittivity, a high frequency-quality factor, a small absolute value temperature coefficient of resonance frequency, and a low sintering temperature.

### BACKGROUND OF THE INVENTION

The development of information communication equipment such as mobile communication equipment in recent years has led to an increasing expectation for enhanced performance of dielectric ceramics for microwave applications to meet property requirements of such information communication equipment. Specifically, although properties required of ceramic compositions for dielectric ceramics vary depending upon applications, commonly required properties include high relative permittivity for reducing the size of devices, a high frequency-quality factor for suppressing attenuation, a reduction in absolute value of temperature coefficient of resonance frequency for improving the thermal stability, and a low sintering temperature and unreactivity with an internal conductor material for simultaneous firing of the ceramic composition and the internal conductor material.

Under the above circumstances, ZnO—Nb₂O₅-based compositions (Japanese Patent Laid-Open No. 37429/1995: patent document 1 and U.S. Pat. No. 5,756,412: patent document 4) and compositions comprising CuO, V₂O₅, and Bi₂O₃ added to the ZnO—Nb₂I₅-based composition (Japanese Patent Laid-Open No. 169330/1995: patent document 2) have been developed. Further, ZnO—Nb₂O₅—TiO₂-based compositions (Japanese Patent Laid-Open No. 44341/2000: patent document 3) and ZnO—Nb₂O₅—CaTiO₃-based compositions (Journal of the European Ceramic Society 23 (2003) 2479-2483: non-patent document 1) have also been developed.

These compositions, however, do not simultaneously satisfy all the above property requirements. For example, some of the conventional compositions had a large absolute value temperature coefficient. Some other conventional compositions had a high relative permittivity, a high frequency-quality factor, and a low absolute value temperature coefficient, but on the other hand, they required a high sintering temperature. Further, some other conventional compositions had a low required firing temperature, but on the other hand, they were reactive with silver which is contemplated as an internal conductor material. The above properties are mutually correlated with each other. Accordingly, an enhancement in some properties results in deterioration of other properties, and, thus, it has been difficult to produce a composition simultaneously satisfying all the above property requirements.

For example, the low-temperature sintered material disclosed in non-patent document 1 is composed mainly of ZnO—Nb₂O₅—CaTiO₃, and a few accessory components have been added as a firing aid to make it possible to fire the material at a lower temperature. This material, however, is reactive with silver and cannot be used as a material for low-temperature fired laminated substrates where silver is used as an internal conductor. A possible reason for this is that the main component CaTiO₃ is reacted with ZnO and Nb₂O₅ at a high temperature to give TiO₂ which is then disadvantageously reacted with an internal conductor electrode.

### DISCLOSURE OF THE INVENTION

In view of the above problems of the prior art, the present invention has been made, and an object of the present invention is to provide a dielectric ceramic composition having a high relative permittivity, a high frequency-quality factor, a small absolute value temperature coefficient, a low sintering temperature, and unreactivity with an internal conductor material. A preferred object of the present invention is to provide a dielectric ceramic composition for microwave applications, which has a relative permittivity of 19.1≦∈r≦25.2, a frequency-quality factor of 1680 to 10515 GHz, and a resonance frequency temperature coefficient (Tcf) of −31.9 to +32.1 ppm/° C., can be sintered at a temperature at or below the melting point of an internal conductor formed of, for example, an Ag—Pd-base (silver-palladium-base) alloy, an Ag—Pt-base (silver-platinum-base) alloy, an Ag—Au-base (silver-gold-base) alloy, an Ag—Cu-base (silver-copper-base) alloy, or a simple substance of Ag, Cu or Au, and, at the same time, is not reactive with these internal conductors.

The above object of the present invention can be attained by a dielectric ceramic composition characterized by comprising: a main component represented by general formula xZnO.xNb₂O₅.yCaTiO₃.zCaO, wherein 37≦x≦50, 10≦y≦60, 3≦z≦40, and x+y+z=100; and a boron (B) oxide as an accessory component in an amount of 0.3 to 3.0 parts by weight in terms of B₂O₃ based on said main component.

In a preferred embodiment of the present invention, the dielectric ceramic composition further comprises a copper (Cu) oxide as an accessory component in an amount of 0.05 to 5.0 parts by weight in terms of CuO.

In another preferred embodiment of the present invention, the dielectric ceramic composition does not exhibit any X-ray diffraction peak derived from TiO₂.

The dielectric ceramic composition according to the present invention can simultaneously satisfy all the requirements of relative permittivity, frequency-quality factor, and temperature coefficient, can be sintered at a low temperature at or below the melting point of Ag, Cu, or Au as a simple substance or an alloy composed mainly of Ag, Cu, or Au, which is contemplated as an internal conductor material, and can suppress the precipitation of TiO₂ crystals by virtue of the addition of CaO and does not have any adverse effect, derived from a chemical reaction between the internal conductor and TiO₂, on the internal conductor.

The dielectric ceramic composition according to the present invention has an additional effect that it can be produced by a simple process. Specifically, since the main component and the accessory component can be calcined together, the production process can be simplified as compared with the conventional process in which an accessory component is added to a previously calcined main component, and the mixture is then subjected to secondary calcination. Further, the recovery of the dielectric ceramic composition can be improved, and the cost can be reduced.

### BRIEF DESCRIPTION OF THE DRAWINGS

FIG. 1 is an X-ray diffraction pattern of a ZnO—Nb₂O₅—CaTiO₃-based composition which is a conventional composition;

FIG. 2 is an X-ray diffraction pattern of a ZnO—Nb₂O₅—CaTiO₃—CaO-based composition which is a composition of the present invention;

FIG. 3 is a photomicrograph of a fine pattern formed on a substrate by forming a silver conductor on a ZnO—Nb₂O₅—CaTiO₃-based composition, which is a conventional composition, firing the composition and the silver conductor together, and then forming the fine pattern on the substrate; and

FIG. 4 is a photomicrograph of a fine pattern formed on a substrate by forming a silver conductor on a ZnO—Nb₂O₅—CaTiO₃—CaO-based composition, which is a composition according to the present invention, firing the composition and the silver conductor together, and then forming the fine pattern on the substrate.

### BEST MODE FOR CARRYING OUT THE INVENTION

Embodiments of the present invention will be described.

Dielectric Ceramic Composition

The dielectric ceramic composition according to the present invention comprises a main component represented by general formula xZnO.xNb₂O₅.yCaTiO₃.zCaO and a boron oxide and preferably a copper oxide as an accessory component. In the main component, x, y and z satisfy the following relationship: 37≦x≦50, 10≦y≦60, 3≦z≦40 and x+y+z=100. The content of each accessory component based on 100 parts by weight of the main component is 0.3 to 3.0 parts by weight for the boron oxide in terms of B₂O₃ and is 0.05 to 5.0 parts by weight for the copper oxide in terms of CuO which is preferably added as an additional accessory component.

Property Requirements

The following properties are mainly required of the dielectric ceramic composition according to the present invention.

The dielectric ceramic composition according to the present invention is mainly contemplated for use in applications of electronic devices using an Ag—Pd-base alloy, an Ag—Pt-base alloy, an Ag—Au-base alloy, an Ag—Cu-base alloy, or a simple substance of Ag, Cu or Au as an internal conductor, and examples of preferred applications include antennas, laminated filters, baluns, duplexers, and laminated substrates. For some applications, the dielectric ceramic composition may be used in combination with a composition having a low relative permittivity.

In producing the above electronic devices comprising an internal conductor, since simultaneous firing of the internal conductor and the dielectric ceramic composition can render the production process efficient, it is an important property that the dielectric ceramic composition can be sintered at a temperature at or below the melting point of the internal conductor. Specifically, the sintering temperature is desirably 920° C. or below, preferably 900° C. or below, more preferably 880° C. or below.

In general, when the relative permittivity (∈r) is higher, the possible reduction level of the size of electronic devices is larger. Accordingly, a high relative permittivity is preferred. For example, when the dielectric ceramic composition according to the present invention is used in high-frequency dielectric filters, since the wavelength of the filter depends upon the magnitude of the relative permittivity, a larger relative permittivity is advantageous for reducing the size of the filter. The frequency-quality factor, however, is generally lowered as the relative permittivity is increased. Therefore, the high relative permittivity is not always preferred unconditionally. In the dielectric ceramic composition according to the present invention, the relative permittivity value is not less than 19.1, preferably not more than 25.2, more preferably not less than 20 and not more than 25.

A lowering in frequency-quality factor (f.Q property) means that the loss of the electronic device is increased. Accordingly, the frequency-quality factor value should be not less than a certain value. In the dielectric ceramic composition according to the present invention, the frequency-quality factor is not less than 1680 GHz, preferably not less than 1800 GHz, more preferably not less than 4000 GHz.

The temperature coefficient of the resonance frequency (Tcf or τf; often referred to simply as “temperature coefficient”) means the degree of change in resonance frequency upon a temperature change. Accordingly, it can be said that the thermal stability enhances with reducing the absolute value of the temperature coefficient. In the dielectric ceramic composition according to the present invention, the temperature coefficient is −31.9 to +32.1 ppm/° C., preferably −30 to +30 ppm/° C., more preferably −20 to +20 ppm/° C., still more preferably −10 to +10 ppm/° C.

In the present invention, the temperature coefficient (ppm/° C.) is calculated by the following equation:

Tcf=[(f85° C.−f25° C.)/f25° C.]×1000000/60

wherein Tcf represents the temperature coefficient of relative permittivity at 25° C. to 85° C.; f85° C. represents resonance frequency at 85° C.; and f25° C. represents resonance frequency at 25° C.

As described above, the dielectric ceramic composition according to the present invention is mainly used, for example, for applications of electronic devices using an alloy composed mainly of Ag, Cu and Au as an internal conductor. To this end, it is preferred to avoid adverse effect caused by interaction between the internal conductor material and the dielectric ceramic composition, for example, during sintering. That is, the compatibility of the dielectric ceramic composition and the internal conductor material in sintering is preferably good. Further, as described above, when TiO₂ crystals are present within the dielectric ceramic composition, interaction occurs between TiO₂ crystals and the internal conductor material, disadvantageously resulting in the disappearance of the internal conductor material upon sintering due to a reaction between the internal conductor material and the dielectric ceramic composition, or the diffusion of the internal conductor material. Accordingly, the prevention of the interaction between the internal conductor material and the dielectric ceramic composition can be said to be the prevention of the precipitation of TiO₂ crystals.

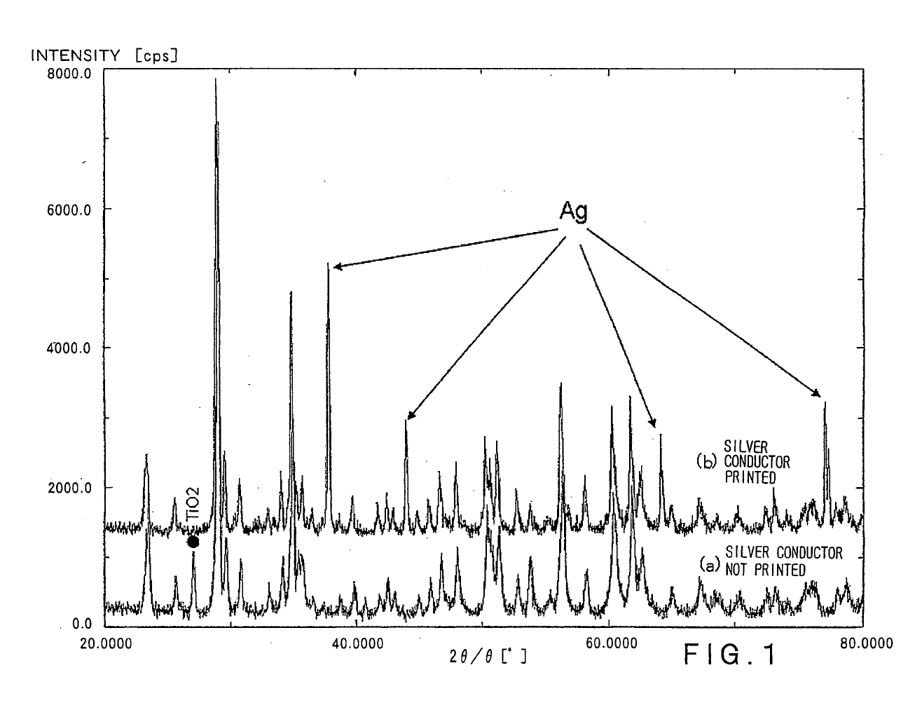

FIG. 1 shows an X-ray diffraction pattern of a ZnO—Nb₂O₅—CaTiO₃-based composition which is a conventional composition. In FIG. 1, (a) represents an X-ray diffraction pattern of a sinter of the dielectric material and (b) represents an X-ray diffraction pattern of a sinter obtained by simultaneously sintering the dielectric material and an internal conductor material (silver). As can be seen from (a) in FIG. 1, an X-ray diffraction peak of TiO₂ in the sinter of the dielectric material appears around 27 degrees, indicating that TiO₂ crystals have been precipitated. On the other hand, as can be seen from (b) in FIG. 1, in the X-ray diffraction pattern of the co-sinter of the dielectric material and silver, the intensity of the X-ray diffraction peak derived from TiO₂ is very weak and is nearly zero. This suggests that, upon the partial liberation of TiO₂ from the main component CaTiO₃, the liberated TiO₂ is reacted with the silver conductor, resulting in a reduction in the amount of the silver conductor.

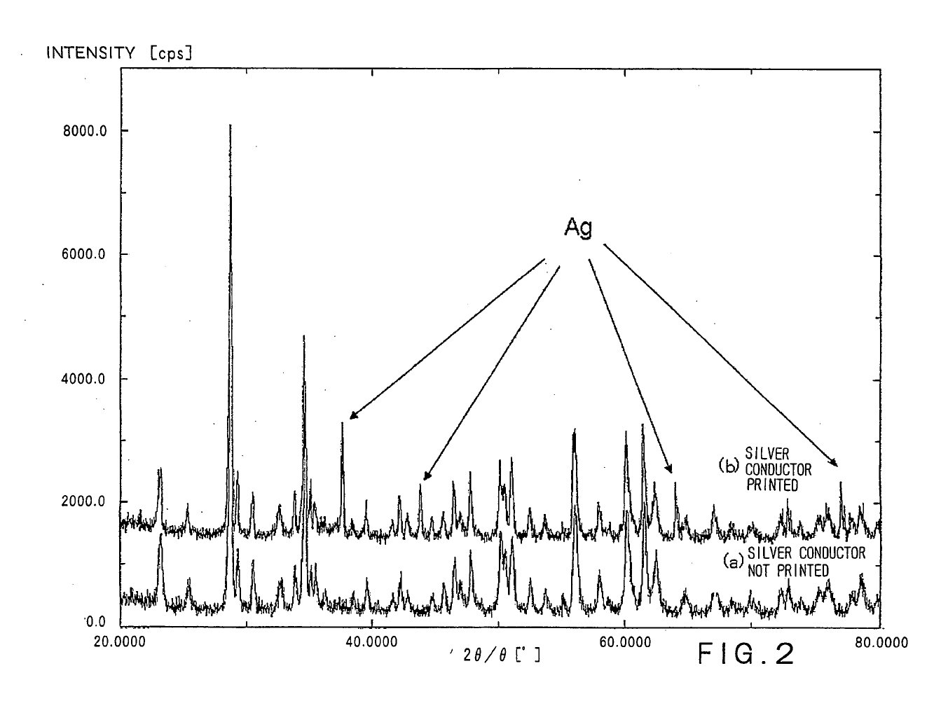

FIG. 2 shows an X-ray diffraction pattern of a ZnO—Nb₂O₅—CaTiO₃—CaO-based composition which is a composition according to the present invention. In FIG. 2, (a) represents an X-ray diffraction pattern of a sinter of the dielectric material and (b) represents an X-ray diffraction pattern of a sinter obtained by co-sintering the dielectric material and a conductor (silver). As can be seen from (a) in FIG. 2, any X-ray diffraction peak derived from TiO₂ in the dielectric material does not appear around 27 degrees, indicating that TiO₂ crystals have not been precipitated. Further, as can be seen from (b) in FIG. 2, also in an X-ray diffraction peak of the co-sinter of the dielectric material and silver, any diffraction peak derived from TiO₂ in the dielectric material does not appear. In the dielectric ceramic composition according to the present invention, the precipitation of TiO₂ crystals considered attributable to the reaction between the electric ceramic composition and the silver conductor could have been suppressed by the addition of a given amount of CaO.

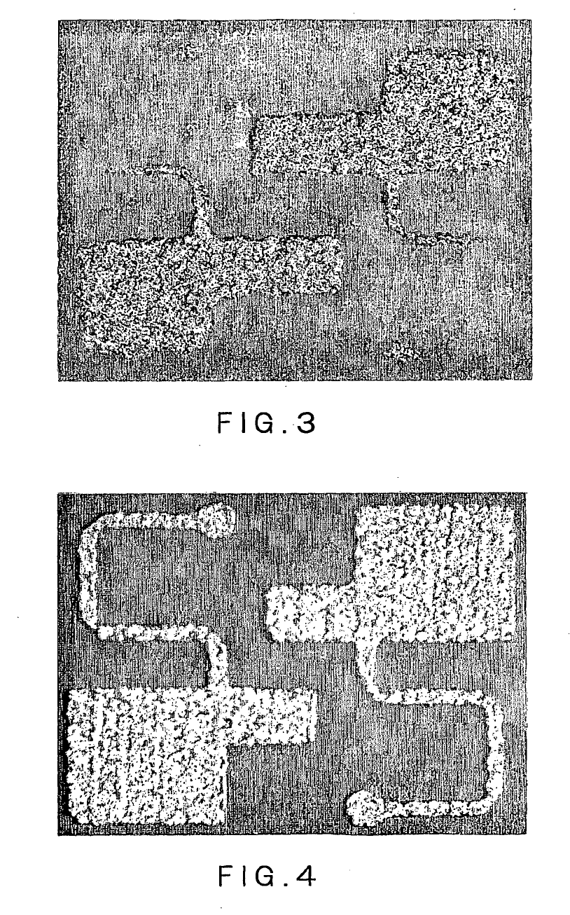

FIG. 3 is a microphotograph of a product produced by forming a silver conductor on a ZnO—Nb₂O₅—CaTiO₃-based composition, which is a conventional composition, and then holding the assembly at 870° C. for 2 hr for co-sintering of the composition and the silver conductor. The microphotograph shows that the silver conductor partially disappeared due to a reaction between the silver conductor and the dielectric ceramic composition, or the diffusion of the silver conductor.

FIG. 4 is a microphotograph of a product produced by forming a silver conductor on a ZnO—Nb₂O₅—CaTiO₃—CaO-based composition, which is a composition according to the present invention, and then holding the assembly at 870° C. for 2 hr for co-sintering of the composition and the silver conductor. The microphotograph shows that the silver conductor has remained unreacted with the dielectric ceramic composition and the silver conductor has not been substantially lost by the sintering.

Composition Range

Low-temperature sinterabiltiy, relative permittivity, frequency-quality factor, temperature coefficient, compatibility with an internal conductor and other properties are greatly influenced by the composition of the main components in the dielectric ceramic composition. In the dielectric ceramic composition according to the present invention, the following composition range is preferred.

At the outset, CaO functions to suppress the precipitation of TiO₂ crystals and thus to improve the compatibility of the dielectric ceramic composition with the internal conductor, whereby the reaction with the electrode and the diffusion of the electrode within the dielectric material can be suppressed. When the content of CaO, that is, z value, is less than 3% by mole, the temperature coefficient is reduced toward a minus value side and, at the same time, an X-ray diffraction peak derived from TiO₂ appears. That is, TiO₂ crystals are precipitated and are reacted with the conductor electrode, and, consequently, the material is rendered unsuitable for electronic devices using an alloy composed mainly of Ag, Cu and Au as an internal conductor. On the other hand, when the content of CaO, that is, z, exceeds 40% by mole, the temperature coefficient is significantly shifted toward a plus value side and, at the same time, the frequency-quality factor is lowered. A lowering in frequency-quality factor means an increase in loss of the electronic device and thus is unfavorable. Accordingly, the content of CaO is limited to such a range that can ensure the frequency-quality factor. That is, the z value is 3 to 40% by mole, more preferably 7 to 300% by mole, still more preferably 15 to 25% by mole.

When the content of ZnO and Nb₂O₅, that is, x, is less than 37% by mole, the temperature coefficient is increased. Accordingly, the content of ZnO and Nb₂O₅ is limited to such a range that can ensure the temperature coefficient. On the other hand, when the content of ZnO and Nb₂O₅, that is, x, exceeds 50% by mole, an X-ray diffraction peak derived from TiO₂ appears. That is, TiO₂ crystals are precipitated and are reacted with the conductor electrode, whereby the material is rendered unsuitable for use in electronic devices using an alloy composed mainly of Ag, Cu and Au as an internal conductor. Further, in this case, the temperature coefficient is unfavorably significantly shifted toward a minus value side. For the above reason, the x value is 37 to 50% by mole, more preferably 40 to 48% by mole, still more preferably 42 to 47% by mole.

When the content of CaTiO₃, that is, y, is less than 10% by mole, the temperature coefficient is unfavorably significantly shifted toward a minus side. On the other hand, when the content of CaTiO₃, that is, y, exceeds 60% by mole, the temperature coefficient is significantly shifted toward a plus value side and, at the same time, TiO₂ crystals are disadvantageously precipitated and are reacted with the internal conductor. For the above reason, the content of CaTiO₃ is limited to such a range that can ensure the small absolute value temperature coefficient. That is, the y value is 10 to 60% by mole, more preferably 20 to 50% by mole, still more preferably 30 to 40% by mole.

The composition range of the accessory component in the dielectric ceramic composition according to the present invention is preferably as follows.

At the outset, when the content of the boron oxide is less than 0.3 part by weight in terms of B₂O₃ based on the main component, the low-temperature sintering effect attained by the boron oxide is unsatisfactory. On the other hand, when the content of the boron oxide exceeds 3.0 part by weight, disadvantageously, a deterioration in dielectric properties such as a lowered frequency-quality factor takes place. For the above reason, the content of the boron oxide is 0.3 to 3.0 parts by weight, more preferably 0.5 to 2.0 parts by weight, still more preferably 0.6 to 1.6 parts by weight, in terms of B₂O₃ based on the main component.

Copper oxide may be added from the viewpoint of improving the appearance of the product. When the content of the copper oxide exceeds 5.0 parts by weight in terms of CuO based on the main component, the frequency-quality factor is disadvantageously lowered. For this reason, the content of the copper oxide is preferably 0.05 to 5.0 parts by weight, more preferably 0.5 to 4.0 parts by weight, still more preferably 1.0 to 3.0 parts by weight, in terms of CuO based on the main component.

Production Process

The production process of a dielectric ceramic composition according to the present invention will be described.

At the outset, oxides of niobium, zinc and calcium and calcium titanate are provided as main components. In this case, oxides of calcium and titanium may be used as an original raw material instead of calcium titanate. Further, boron oxide and optionally copper oxide as accessory components are also provided. They are weighed in predetermined amounts and are mixed together, and the mixture is calcined. The main component and accessory component materials may not be always oxides. The use of, for example, carbonates, hydroxides, sulfides, and nitrides, which, upon heat treatment in the air, can be converted to oxides, can provide a dielectric ceramic composition equivalent to that in the case where oxides are used.

The raw materials may be mixed together, for example, by wet mixing using water or the like. Calcination is not indispensable, and the dielectric ceramic composition according to the present invention can be provided by firing. Preferably, however, calcination is carried out, for example, from the viewpoint of ensuring the homogeneity of the composition. Further, also when carbonates or hydroxides are used as the raw materials, the calcination is preferably carried out. In this case, for example, calcination under conventional conditions of temperature about 700° C. to 900° C. and time a few hours suffices for contemplated results.

When the calcination has been carried out, the particle size of the resultant calcination product is large, and, thus, pulverization of the calcination product to a predetermined particle diameter to prepare a powder having a narrow particle size distribution is preferred. This pulverization can also improve the sinterability of the material.

The powder thus obtained can be formed into a sheet by a conventional method, for example, doctor blading or extrusion. When the dielectric ceramic composition and the internal conductor are simultaneously sintered, a method may be adopted in which a conventional conductor paste is printed on the sheet, lamination pressing is carried out for integration, and the integrated assembly is then fired. The firing is preferably carried out in an oxygen-containing atmosphere such as air. The firing temperature may be set to a value in the range of 850° C. to 920° C. The firing time is preferably about 0.5 to 10 hr. Firing at the above temperature for the above period of time can realize firing at a low temperature at or below the melting point of Ag, Cu or Au as a simple substance or an alloy composed mainly of Ag, Cu or Au. Accordingly, electronic devices using a low-melting point metal such as Ag, Cu or Au having low resistance as the internal conductor can be realized.

In the present invention, the main component and the accessory component may be simultaneously calcined. This can simplify the production process as compared with the conventional process in which an accessory component is added to a previously calcined main component and the mixture is then subjected to secondary clacination. Further, the recovery of the dielectric ceramic composition can be improved, and the cost can be reduced.

Since the dielectric ceramic composition according to the present invention is free from environmental pollutants such as PbO, Cr₂O₃ and Bi₂O₃, an environmental-friendly low-temperature sintered dielectric material can be provided.

### EXAMPLES

The following Examples further illustrate the present invention.

ZnO, Nb₂O₅, CaCO₃, and CaTiO₃ were provided as main component materials, and CuO and B₂O₃ were provided as accessory component materials. They were weighed in such respective amounts that the mixing ratio among ZnO, Nb₂O₅, CaCO₃, CaTiO₃, CuO and B₂O₃ after firing is as shown in the column of the main component composition in Table 1 below. Pure water was added thereto to a slurry concentration of 30%, followed by wet mixing in a ball mill for 5 hr. The mixture was then dried. The dried powder was calcined in the air at a temperature specified in Table 1 for two hr.

Pure water was added to the powder thus obtained to a slurry concentration of 30%. The slurry was subjected to wet pulverization in a ball mill for 24 hr, followed by drying to prepare a dielectric material mixture.

Next, one part by weight of polyvinyl alcohol was added as a binder to 100 parts by weight of each of the dielectric material mixtures thus obtained. The mixtures were dried and were passed through a mesh with an opening size of 150 μm for granulation.

The granule powder thus obtained was molded by a press molding machine at a surface pressure of 1 ton/cm² to prepare cylindrical specimens having a size of 17 mmφ in diameter×8 mm in thickness. The specimens were then fired in the air at a temperature specified in Table 1 for 2 hr to prepare dielectric ceramic composition samples.

The samples were polished to a cylindrical form having a size of 13.5 mmφ in diameter×6.5 mm in thickness and were measured for dielectric properties. The relative permittivity (∈r) and the no-load Q were measured by a hollow-type dielectric material resonator method. The measurement frequency was 4 to 6 GHz. The results are shown in Table 1.

TABLE 1

| | | | | | | | | | | | Reaction With |
|---|---|---|---|---|---|---|---|---|---|---|---|
| | x | y | z | CuO | B2O3 | Calcination | firing | | f · Q | τ f | internal |
| | mol % | mol % | mol % | wt % | wt % | temp. ° C. | temp. ° C. | ε r | GHz | ppm/° C. | conductor |
| Ex. 1 | 50 | 10 | 40 | 0 | 3 | 800 | 850 | 25.2 | 2469 | 32.1 | Not reacted |
| Ex. 2 | 46.2 | 50 | 3.8 | 2 | 1.5 | 800 | 870 | 19.8 | 6408 | −28.2 | Not reacted |
| Ex. 3 | 46.2 | 50 | 3.8 | 0 | 2 | 800 | 900 | 20.7 | 7013 | −25.7 | Not reacted |
| Ex. 4 | 46.2 | 30.8 | 23.1 | 2 | 1.5 | 800 | 900 | 19.1 | 9054 | −31.9 | Not reacted |
| Ex. 5 | 45.5 | 31.4 | 23.1 | 2 | 1 | 800 | 900 | 20.2 | 10515 | −12.3 | Not reacted |
| Ex. 6 | 45.5 | 28.4 | 26.1 | 2 | 1 | 800 | 900 | 19.7 | 8192 | −17.6 | Not reacted |
| Ex. 7 | 46.5 | 27.4 | 26.1 | 2 | 1 | 800 | 900 | 19.2 | 8671 | −25.9 | Not reacted |
| Ex. 8 | 44.7 | 31.4 | 23.9 | 2 | 1 | 800 | 870 | 20.3 | 9476 | −8.5 | Not reacted |
| Ex. 9 | 44.7 | 31.4 | 23.9 | 2 | 1 | 800 | 900 | 20.8 | 9642 | −1.5 | Not reacted |
| Ex. 10 | 44.7 | 31.4 | 23.9 | 2 | 0.8 | 800 | 870 | 20.7 | 9911 | −2.7 | Not reacted |
| Ex. 11 | 44.7 | 31.4 | 23.9 | 2 | 0.8 | 800 | 900 | 20.9 | 9303 | −3.1 | Not reacted |
| Ex. 12 | 43.5 | 49.1 | 7.4 | 2 | 1.5 | 800 | 870 | 21.8 | 2442 | −5.0 | Not reacted |
| Ex. 13 | 43.1 | 31.4 | 25.5 | 2 | 1 | 800 | 870 | 21.7 | 4926 | 20.5 | Not reacted |
| Ex. 14 | 43.1 | 35.3 | 21.6 | 2 | 1.5 | 800 | 870 | 21.4 | 5976 | 8.5 | Not reacted |
| Ex. 15 | 43.1 | 35.3 | 21.6 | 2 | 1.5 | 800 | 880 | 21.7 | 5301 | 5.4 | Not reacted |
| Ex. 16 | 43.1 | 35.3 | 21.6 | 2 | 1.5 | 800 | 900 | 21.7 | 4174 | 3.5 | Not reacted |
| Ex. 17 | 43.1 | 35.3 | 21.6 | 2 | 1 | 800 | 870 | 21.6 | 6922 | 13.7 | Not reacted |
| Ex. 18 | 43.1 | 35.3 | 21.6 | 2 | 1 | 800 | 900 | 21.8 | 6382 | 12.8 | Not reacted |
| Ex. 19 | 43.1 | 35.3 | 21.6 | 2 | 1 | 850 | 870 | 21.6 | 7089 | 11.9 | Not reacted |
| Ex. 20 | 43.1 | 35.3 | 21.6 | 2 | 1 | 850 | 900 | 21.8 | 6402 | 12.7 | Not reacted |
| Ex. 21 | 43.1 | 35.3 | 21.6 | 2 | 1 | 900 | 870 | 21.5 | 6408 | 9.9 | Not reacted |
| Ex. 22 | 43.1 | 35.3 | 21.6 | 2 | 1 | 900 | 800 | 21.9 | 5732 | 9.7 | Not reacted |
| Ex. 23 | 43.1 | 35.3 | 21.6 | 2 | 1.2 | 800 | 870 | 19.1 | 7056 | 6.7 | Not reacted |
| Ex. 24 | 43.1 | 35.3 | 21.6 | 2 | 1.2 | 800 | 900 | 21.3 | 7337 | 9.1 | Not reacted |
| Ex. 25 | 43.1 | 35.3 | 21.8 | 2 | 0.8 | 800 | 870 | 21.8 | 7527 | 9.6 | Not reacted |
| Ex. 26 | 43.1 | 35.3 | 21.6 | 2 | 0.8 | 800 | 900 | 22.1 | 7104 | 9.2 | Not reacted |
| Ex. 27 | 43.1 | 35.3 | 21.6 | 2 | 0.8 | 850 | 870 | 21.9 | 7951 | 9.1 | Not reacted |
| Ex. 28 | 43.1 | 35.3 | 21.6 | 2 | 0.8 | 850 | 900 | 22.2 | 7516 | 9.2 | Not reacted |
| Ex. 29 | 43.1 | 35.3 | 21.6 | 2 | 0.8 | 900 | 870 | 21.7 | 7690 | 8.5 | Not reacted |
| Ex. 30 | 43.1 | 35.3 | 21.6 | 2 | 0.8 | 900 | 900 | 22.1 | 7390 | 8.6 | Not reacted |
| Ex. 31 | 42 | 47.3 | 10.7 | 2 | 1.5 | 800 | 870 | 22.8 | 1800 | 14.9 | Not reacted |
| Ex. 32 | 37 | 60 | 3 | 5 | 0.3 | 800 | 920 | 23.6 | 1836 | 12.8 | Not reacted |
| Ex. 33 | 37 | 60 | 3 | 5.5 | 0.3 | 800 | 920 | 23.3 | 1685 | 12.5 | Not reacted |
| Comp. Ex. 1 | 43.1 | 54 | 2.9 | 2 | 1 | 800 | 870 | 21.8 | 2442 | −5.2 | Reacted |
| Comp. Ex. 2 | 48 | 10 | 42 | 2 | 0.8 | 800 | 900 | 32.5 | 1672 | 74.6 | Not reacted |
| Comp. Ex. 3 | 33 | 44 | 23 | 2 | 1.5 | 800 | 900 | 32.6 | 1377 | 166.3 | Not reacted |
| Comp. Ex. 4 | 87 | 10 | 3 | 2 | 1 | 800 | 900 | 20.2 | 22600 | −69.3 | Reacted |
| Comp. Ex. 5 | 87 | 8 | 5 | 2 | 1 | 800 | 900 | 20.4 | 19200 | −71.6 | Reacted |
| Comp. Ex. 6 | 35 | 62 | 3 | 5 | 0.3 | 800 | 920 | 24.2 | 1570 | 13.2 | Not reacted |
| Comp. Ex. 7 | 37 | 60 | 3 | 5 | 0.2 | 800 | 920 | Not densified | | | |
| Comp. Ex. 8 | 50 | 10 | 40 | 0 | 3.5 | 800 | 850 | 24.9 | 1388 | 35.8 | Not reacted |
| Comp. Ex. 9 | 85 | 10 | 5 | 2 | 1 | 800 | 900 | 22.4 | 17000 | −65.0 | Not reacted |
| Comp. Ex. 10 | 60 | 10 | 30 | 2 | 1.5 | 800 | 870 | 19.1 | 13108 | −55.1 | Not reacted |
| Comp. Ex. 11 | 51.9 | 22.2 | 25.9 | 2 | 1.5 | 800 | 900 | 17.0 | 5898 | −46.6 | Not reacted |
| Comp. Ex. 12 | 35 | 44 | 21 | 2 | 1.5 | 800 | 900 | 30.0 | 1993 | 131.0 | Not reacted |

1. A dielectric ceramic composition comprising:
a main component represented by general formula
xZnO.xNb₂O₅.yCaTiO₃.zCaO
wherein 37≦x≦50, 10≦y≦60, 3≦z≦40, and x+y+z=100; and
a boron (B) oxide as an accessory component in an amount of 0.3 to 3.0 parts by weight in terms of B₂O₃ based on said main component.

2. The dielectric ceramic composition according to claim 1, which further comprises a copper (Cu) oxide as an additional accessory component in an amount of 0.05 to 5.0 parts by weight in terms of CuO.

3. The dielectric ceramic composition according to claim 1, wherein any X-ray diffraction peak derived from TiO₂ does not appear.
